(19) United States
(12) Patent Application Publication
(10) Pub. No.: US 2005/0010490 A1
(43) Pub. Date: Jan. 13, 2005

(54) Internet-based electronic lottery card

(76) Inventor: Shulin Liu, Liaoning (CN)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/889,794

(22) Filed: Jul. 13, 2004

Related U.S. Application Data
(63) Continuation of application No. PCT/CN03/00028, filed on Jan. 15, 2003.

(30) Foreign Application Priority Data
Jan. 15, 2002 (CN) 02109049.1

(51) Int. Cl. G06F 17/60

(52) U.S. Cl. 705/26

(57) ABSTRACT

An electronic lottery card transferred via the Internet has two functions, including e-card and lottery, and is presentable. A method of transferring the electronic lottery card through the Internet includes: (1) providing an electronic lottery card server; (2) allowing a user to log into the server; (3) displaying e-cards and lotteries to be selected; (4) allowing the user to choose e-card/e-cards and lottery/lotteries, to input information about the receiver and to confirm; (5) automatically encrypting the information confirmed, storing the information in a database, sending the electronic lottery card to the receiver, and notifying the receiver; and (6) upon the confirmation of the receiver that he/she has received the electronic lottery card, inputting the information into the database.

### CROSS-REFERENCE TO RELATED APPLICATIONS

This application is a continuation of International Application No. PCT/CN03/00028, filed Jan. 15, 2003, which was published in the English language on Jul. 24, 2003, under International Publication No. WO 03/061212 and the disclosure of which is incorporated herein by reference.

### BACKGROUND OF THE INVENTION

The present invention relates to an Internet-based electronic lottery card, and also relates to a method of transferring the electronic lottery card through the Internet.

The Internet has gradually become an indispensable part of daily life. Sending electronic cards via Email through the Internet has become one way of greeting. Playing lottery is fun and buying lottery through the Internet is recognized and accepted gradually. Although lotteries and electronic cards have provided lots of fun and convenience for daily life, they do not have liquidity and transferability and especially presentability.

### BRIEF SUMMARY OF THE INVENTION

The present invention provides a presentable Internet-based electronic lottery card and a method of transferring the electronic lottery card through the Internet.

According to the present invention, an Internet-based electronic lottery card is provided, wherein the Internet is used as its carrier, i.e., it depends on the existence of the Internet, and the card functions of both e-card and lottery, and is presentable.

According to the present invention as well, a method of transferring the electronic lottery card through the Internet is provided, the method including:
1) providing an electronic lottery card server;
2) allowing a user to log into the server;
3) displaying e-cards and lotteries to be selected;
4) allowing the user to choose e-card/e-cards and lottery/lotteries, to input information about the receiver and to confirm;
5) automatically encrypting the information confirmed, storing the information in a database, sending the electronic lottery card to the receiver, and notifying the receiver; and
6) upon the confirmation of the receiver that he/she has received the electronic lottery card, inputting the information into the database.

According to the present invention, the information about the receiver is the email address of the receiver. Ways to notify the receiver include QQ, SMS and MMS.

In addition, in the present invention, the lottery is any kind of computer lottery legalized for sale.

The present invention provides:
1) a way of transmitting information with service fee;
2) a new kind of electronic gift card, with which the receiver can receive greetings and meanwhile has chance to win lottery, therefore, it greatly increases the value of the gift cards;
3) methods to collect and transfer client information by a company; and
4) methods for a company to advertise with a prize attached.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flow chart of transmission; and

FIG. 2 is a flow chart of receiving.

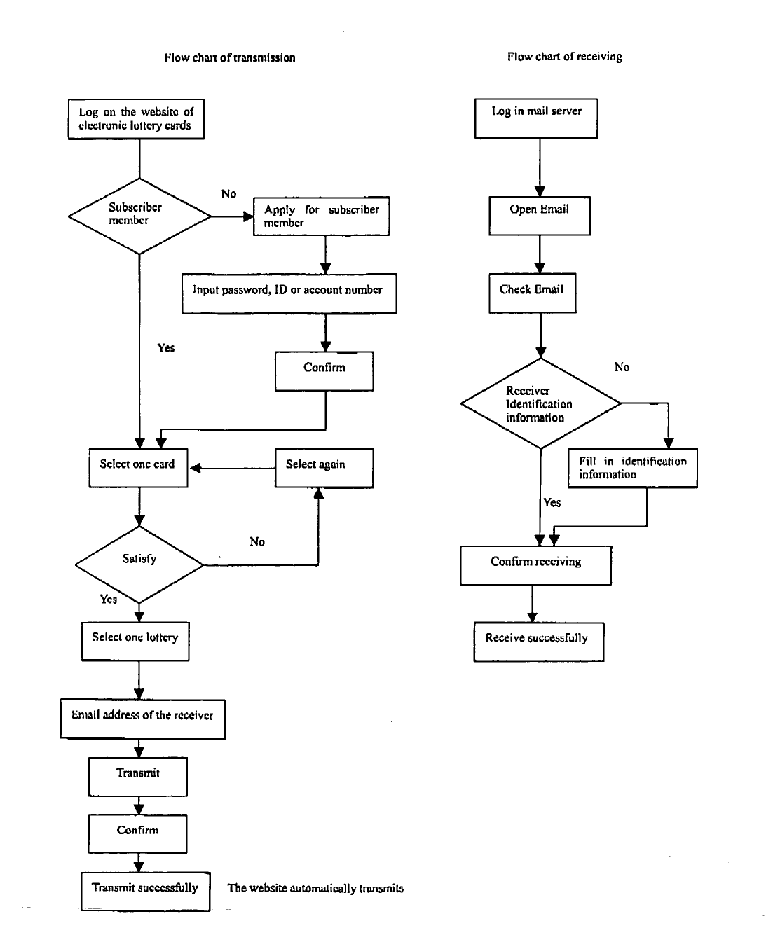

### DETAILED DESCRIPTION OF THE INVENTION

With reference to the embodiments shown in the drawings, the present invention is further described in detail hereinafter.

First, an electronic lottery card website is set up, i.e., an Internet-based lottery website selling electronic lottery cards or delivering gift lottery information, which is the carrier of the electronic lottery card.

Second, a user, who wants to send an electronic lottery gift card, visits the electronic lottery website, and logs in as a member. If the user is a first time visitor, he/she needs to apply for the membership and get approval. Upon completing this step, the server will automatically provide information of electronic lottery cards which is displayed on the screen of the client side, i.e., electronic cards are provided which can be selected by the user and lotteries whose types, issue numbers and quantities can be selected by the user. The payment method includes: credit card, money transfer through post office or cell phone bills.

Next, the user selects electronic card and lottery, inputs the email address of the receiver, and confirms. Then the server automatically encrypts above information, stores the information in a database in a hard disk which is protected by a firewall, and delivers the electronic lottery card generated by the server to the receiver's email box. That is to say, the user inputs the following information into the electronic lottery card: types, issue numbers and betting number/results of lottery bought; and name, telephone or cell phone number, valid identification number, email address etc. of the buyer and the receiver. The website will inform the receiver in effective ways through the Internet, which include, but are not limited to, the server automatically notifies the receiver by way of QQ and SMS, MMS.

When the receiver receives the notification, he/she can log into his/her email server and open his/her email account to check whether an electronic lottery card has been received. Upon receiving of the electronic lottery card, the receiver clicks on the card to confirm. The email server will send the confirmation to the electronic lottery card server through the Internet, then the electronic lottery card server will automatically input the confirmation to the above database in hard disk for the purpose of data backup. If there is no information for the identification of the receiver (the user did not input this information), the receiver input his/her identification information to the form provided by the mail server, the lottery server will automatically input this information to the above-mentioned database in hard disk. In details, after receiving the electronic lottery card, the receiver fills in his/her name, telephone/cell phone number and valid identification number in the electronic lottery card received and returns confirmation to the electronic lottery card server via Email. Upon receiving of the confirmation by the electronic lottery card server, the transmission-receiving process of the electronic lottery card is accomplished.

If the receiver's information filled in is correct, the step of confirmation can be eliminated from the process. This is determined according to the design of the website. As shown above, the card of the present invention has the effect and function of both a lottery and gift card, especially because of its presentability.

In the present invention, the source of the lottery includes all kinds of lottery that are legalized for sale, i.e. computer lottery.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An Internet-based electronic lottery card that is both an e-card and a lottery card, the electronic lottery card being transferred by the Internet and being presentable.

2. A method of delivering an electronic lottery card through the Internet comprising:
1) providing an electronic lottery card server;
2) allowing a user to log into the server;
3) displaying e-cards and lotteries to be selected;
4) allowing the user to choose e-card/e-cards and lottery/lotteries, to input information about the receiver and to confirm;
5) automatically encrypting the information confirmed, storing the information in a database, sending the electronic lottery card to the receiver, and notifying the receiver; and
6) upon the confirmation of the receiver that he/she has received the electronic lottery card, inputting the information into the database.

3. A method as recited in claim 2 wherein the information about the receiver is the email address of the receiver.

4. A method as recited in claim 2 wherein the receiver is notified by one of QQ, SMS and MMS.

5. A method as recited in claim 2 wherein the said lottery is any kind of computer lottery legalized for sale.
